(19) United States
(12) Patent Application Publication
(10) Pub. No.: US 2015/0308745 A1
(43) Pub. Date: Oct. 29, 2015

(54) ARCH BRICK, CYLINDRICAL INTERNAL LINING OF A ROTARY KILN AND ROTARY KILN

(71) Applicant: Refractory Intellectual Property GmbH & Co. KG, Wien (AT)

(72) Inventors: Andreas Wiry, Mautern (AT); Roland Krischanitz, Maria Anzbach (AT)

(21) Appl. No.: 14/648,487

(22) PCT Filed: Jan. 6, 2014
(86) PCT No.: PCT/EP2014/050068

§ 371 Date: May 29, 2015

(30) Foreign Application Priority Data
Mar. 27, 2013 (EP) 13161360.6

(51) Int. Cl. F27D 1/04; F27B 7/28

(52) U.S. Cl. CPC F27D 1/045; F27B 7/28; F27D 2001/047

(57) ABSTRACT

The invention relates to an arch brick in accordance with DIN 1082-4, edition January 2007, a cylindrical inner lining of a rotary kiln, which lining comprises these arch bricks, and a rotary kiln with such lining and such arch bricks.

The invention relates to an arch brick in accordance with German Industrial Standard DIN 1082-4, edition January 2007, a cylindrical inner lining of a rotary kiln, wherein the lining comprises these arch bricks and a rotary kiln with said lining and said arch bricks.

The arch bricks, the lining and the rotary kiln are described hereinafter in a fitted (use) position of the kiln (furnace).

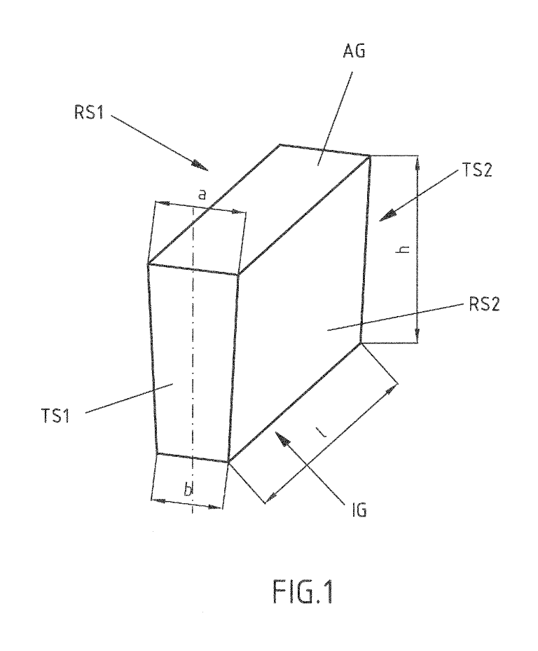

An arch brick according the Standard is displayed in FIG. 1 and provides the following six surfaces:
one rectangular (square) outer base AG of a size a×l
one rectangular (square) inner base IG of a size b×l
two rectangular (square) side faces RS1, RS2 each of size l×h
two trapezoidal front faces TS1, TS2 each of a size a/b×h, wherein a/b describes two sides of different length of the front faces

These arch bricks are used for the lining of a rotary kiln, for example a rotary kiln to produce cement clinker. The square larger base AG then extends outwardly, adjacent to the outer envelope of the rotary kiln, while the square smaller base IG extends inwardly, next to the inner space of the kiln. The bricks are arranged in such a way, that their length (l) extends in an axial direction of the kiln.

The general fitting of the arch bricks in a rotary kiln is described in the said Standard and the following prior art: DE2643412, DE29921607 U1 and may be summarized as follows: The arch bricks are arranged in ring-like segments in a peripheral direction of the kiln next to each other. Several segments are arranged next to each other in said axial direction of the kiln.

During kiln operation the refractory lining bricks undergo substantial mechanical treatment. The following factors are important:
a compressive load in axial direction, towards the kiln exit (outlet opening), because of the inclination of the kiln (towards the kiln exit) and the net weight (dead weight) of the bricks
the thermal expansion of the refractory material of said bricks (e.g. at the kiln entrance of a cement rotary kiln the temperature may be 1.000° C., at the kiln exit it may be ca. 1.500° C.)
the rotation of the kiln
the weight and the friction between the lining and the kiln run (kiln charge).

Without special treatments especially the arch bricks in the second half of the kiln, towards the kiln exit, crack. Consequences are frequent repair and stand still times of the kiln as well as high costs.

DE 29921607 U1 proposes to weld a metal ring to the outer kiln envelope. The ring forms a kind of a counter bearing to the axial pressure mentioned above. The ring has a square cross section, wherein the “height” in a radial direction may only be small (in practice ca. 50-70 mm) as the metal material is too little temperature resistant and the temperature increases in the kiln from the outside to the inside.

The small contact and bearing face between ring and refractory lining brick causes a high bearing pressure (contact pressure). Often the stability of the ceramic bricks is exceeded. Cracks occur or bricks are crushed because of the axial forces within the brick lining.

According to DE 29921607U1 counter bearings of triangular cross-section are proposed as well. The corresponding inclined surface (which serves as a bearing surface for the arch bricks arranged in front of it) extends inwardly and towards the kiln exit. Further the fixations of the metal wedges are welded to the kiln envelope as screw connections do not present sufficient stability at these high axial forces.

Although theses wedges present a larger bearing surface, the problem of insufficient temperature resistance remains. Correspondingly the angle of inclination is limited to <20 degrees to allow to protect the metal parts by the refractory bricks arranged radially inside.

It is an object of the invention to present a solution for the described axial loads in a rotary kiln by which the drawbacks mentioned can be avoided.

The invention replaces the known metallic counter bearing and changes the geometry of the refractory arch bricks, which are used for the refractory lining. As no metallic parts are necessary the following advantages may be achieved:
a separate fitting (mounting) step is omitted
the temperature resistance of the refractory lining is far above that of the metal parts
the greater refractoriness makes it possible to use bricks of arbitrary size and shape
the costs of this system are less compared with the described wedges and rings

At first it has to be acknowledged that the axial pressure with the refractory ceramic furnace lining cannot be avoided. The invention yet has found that the functionality of a counter bearing (to compensate the axial pressure within the lining) may be managed by the refractory lining itself, if the lining bricks are divided in a radial direction, thereby providing sloped surfaces between adjacent bricks elements.

These, quasi in-situ formed sloped surfaces are responsible for that the axial pressure load within the refractory furnace lining is at least partially deflected and spread into a radial and peripheral direction. Correspondingly the axial load of the bricks, arranged behind (towards the kiln exit), is reduced and there is an overall much more uniform load distribution within the bricks of said lining.

In using refractory ceramic “counter bearings” there are no restriction with regard to shape and size. In particular the brick parts may be much larger (deeper/“higher”)) then the metal rings. A retrofitting into existing apparatus is possible as the used brick elements geometrically complement with an arch brick of conventional shape and can replace it completely.

In its most general embodiment the invention relates to an arch brick in accordance with DIN 1082-4, edition January 2007, which is separated into two discrete (separate) brick elements (parts) along at least one separation plane, which extends from base AG to a front face TS2 or a further base IG.

The central idea of the invention thus is, to divide a known arch brick into several parts (two, three or more). The parts of such a set may be put together again in a form fit way to represent an arch brick, namely in a perfect form fit way or with (expansion) joints between the respective parts (elements) and/or in such a way that expansion joints are formed towards adjacent arch bricks. Theses expansion joints may be filled during or after assembly of the lining with seals, especially elastic seals like fibre/fiber materials.

It derives unambiguously from the described run of the “separation plane” between brick parts of one set that the separation plane (separation joint) extends in a radial direction of the kiln in an inclined manner. In other words: The geometry and arrangement of at least one brick part may be similar to the geometry and arrangement of a metallic mounting part according to DE 29921607U1.

This sloped surface extends in an increasing manner (from the kiln entrance to the kiln exit and from the kiln envelope to the kiln chamber) and serves as well as an abutting surface for the lining bricks arranged in front of it (towards the kiln entrance). Thus the axial load of the bricks is compensated by said “separating plane”, which has the function of a counter bearing.

The sloped surface serves to deviate the axial forces of said lining in a radial and peripheral direction of the cylindrical rotary kiln to large extent. At the same time the mechanical load onto this brick part is reduced and a substantially constant load distribution into adjacent areas of the kiln lining is achieved.

If arch bricks according to the invention are arranged next to each other, to form a complete lining ring, the forces are directed towards the kiln envelope because of the ring geometry and thus a further pressure reduction for (into) the refractory material.

Compared with metal parts according to prior art there are additional advantages like:
a substantially higher temperature resistance
therefore the area and the angle of the sloping surface (with respect to the axially extending kiln envelope) may be larger
the use of different types of material with totally different thermal expansion coefficients is avoided

The brick parts may be manufactured from conventional refractory materials, for example materials based on alumina (Al₂O₃), magnesia (MgO), silicon carbide (SiC), zirconia (ZrO₂) etc.

The brick part used to compensate the axial pressure load, can be manufactured from a material of particular high compressive strength, for example from a batch of the following composition (all in mass %):

| Example A: | Example B: |
|---|---|
| Al₂O₃: 40-95 (85) | MgO: 80-95 (90) |
| SiO₂: 2-50 (12) | Al₂O₃: 2-15 (4) |
| SiC: 0-50 | Cr₂O₃: 0-15 |
| ZrO₂: 0-40 | SiO₂: 0.1-2 (0.5) |
| Cr₂O₃: 0-10 | Fe₂O₃: 0.1-10 (4) |
| Fe₂O₃: 0-3 (0.5) | CaO: 0.1-3 (1) |
| Other: 0-3 (2.5) | Other: 0-3 (0.5) |

Numerals in parenthesis relate a specific possible composition.

According to one embodiment the separation plane between adjacent brick parts extends by an angle ≧20 degrees to the outer base AG, although this angle may be much larger, for example ≧25 degrees, ≧30 degrees or ≧40 degrees. It is self-evident that the angle must be <90 degrees to allow its required task as a “compression bearing” or “abutting bearing” respectively. According to one embodiment the angle is ≦75 degrees, often ≦60 degrees or ≦45 degrees.

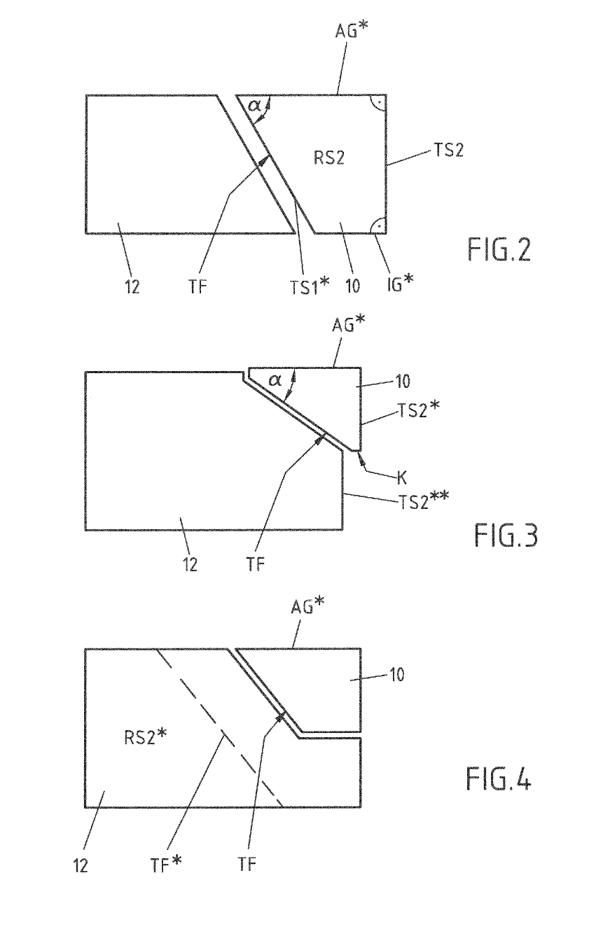

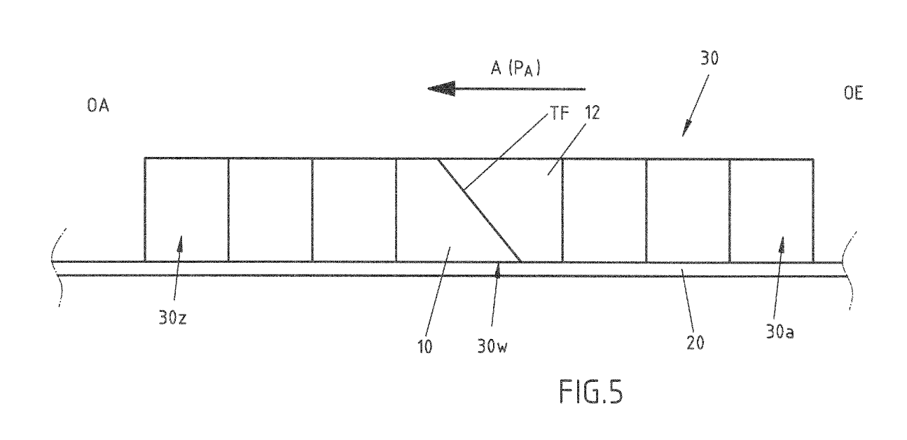

The sloping surface within the arch brick format may also be achieved by cutting an arch brick into two pieces. But embodiments with 3 or more brick parts are possible as displayed by the following figures, which illustrate possible geometries of brick parts and arch bricks:
FIG. 2 discloses a side view of a set of two brick parts, which together form an arch brick according to DIN 1082-4 (FIG. 1). Brick part 10 to the right has two opposed identical sides (side faces) RS1, RS2 of trapezoidal shape, from which only one (RS2) is visible.
The left brick part 12 is shaped correspondingly to part 10, so that both brick parts 10,12 complement with each other in a form-fit manner to represent an arch brick in accordance with DIN 1082-4 (edition January 2007).
Bricks parts 10, 12 may be manufactured by pressing in separate moulds. But they can also be manufactured in cutting a conventional arch brick between its bases AG and IG at right angle to its side faces RS1, RS2.
The side faces RS1, RS2 of said brick part 10 have two right angles, an acute angle and an obtuse angle. The trapezoidal front face TS2 at the right has remained unchanged, a new trapezoidal front surface TS1* is provided by the described separating plane TF between brick parts 10, 12. The inner (in the Figure: lower) base IG* and the outer (in the Figure: upper) base AG* are partial areas of the corresponding bases AG, IG of the standard arch brick. The sloped plane/separating plane TF between brick parts 10, 12 extends by an angle of about 45 degrees with respect to said bases AG*, IG* and from one base AG to the other base IG.
The left brick half 12 is shaped in a way that a complete arch brick is formed together with part 10 when put together in a form-fit way.
FIG. 3 relates to an embodiment, in which the separating joint TF between two brick parts 10,12 extends substantially from the outer base AG to the rear face TS2, such that brick part 10 has about a triangle profile when seen from the side. The separation plane TF is planar, as in FIG. 2, but it could be little arched or provided with different sloping angles. Said angle (α) between base AG* of part 10 and sloped surface/separation plane TF is about 35 degrees.
To avoid chipping (peeling) of any rims these may be edged, as displayed by K in FIG. 3. The basic geometry as well as the basic inventive concept do not change by this.
As FIG. 3 shows, the second brick part 12 has the shape of a pentagon, so that both parts 10, 12 represent a complete arch brick after assembly.
The front face TS2** of part 12 shown in the Figure is arranged slightly offset with respect to front face TS2* or part 10. This allows to provide an expansion joint vis a vis an arch brick adjacent in the axial direction of the kiln, which may be filled by a seal like a fibre material.
The embodiment according to FIG. 4 discloses an edged separation joint TF, so that a trapezoidal shape (in a side view) is realized in the upper right part 10 while the sides RS1*, RS2* of corresponding part 12 each have six corners. Apart from this the example of FIG. 4 is similar to that of FIG. 3.
In FIG. 4 a further partition of part 12 is displayed, namely in dotted lines, wherein the thus formed separation plane TF* runs similar to the partition of parts 10,12 according to FIG. 2.

As already mentioned the axial pressure in said refractory lining increases towards the kiln exit. Therefore it is recommended to arrange one ring, made of arch bricks according to the invention, in this area.

The following alternatives (variants) are in accordance with the invention:
Arrangement of several rings (rows) made of the new arch bricks (in an axial extension of the kiln) one behind the other, namely directly one behind the other or with a distance in between. In the latter case either conventional lining bricks may be arranged between the rings/rows of the new arch bricks or an expansion joint is arranged in between, which may be filled with an elastic joint material like a fibre mat.
A further alternative is characterized by a conventional metal ring, arranged behind a brick layer/ring of arch bricks according to the invention, to serve as an additional retaining means, which then may be designed much smaller, as substantially lower forces must be compensated.
Arrangement of a ring of arch bricks, whereby new (multi-part) arch bricks are arranged with conventional (one piece) arch bricks in an alternating fashion.
The brick layers (rings, alignments) may be arranged in a form-fit manner or with a distance to each other, as well in combination with conventional brick shapes (DE 2643412A, DE29921607U1).
The bricks may be laid in a dry state or with a mortar in between.
The separation plane between adjacent brick parts may be dissimilar 90 degrees with respect to the sides faces, planar or non planar.
Opposed surfaces (RS1, RS2; RS1*, RS2*) of one brick part may have a trapezoidal shape, a triangular shape, may be pentagonally shaped and may be even or uneven.

Correspondingly a cylindrical inner lining of a rotary kiln may have the following features:
The lining extends between a kiln entrance at a first end of the rotary kiln and a kiln exit at a second end of the rotary kiln
The lining is substantially made of ring-like segments arranged one behind the other, wherein
At least one ring-like segment is made at least predominantly of arch bricks according to claim 1, which abut each other with their side faces RS1, RS2 and which larger bases AG are arranged to the outside, wherein
Separation planes TF of the arch bricks extend from the outer bases AG towards the kiln exit.

These arch bricks may be varied as described above.

The invention also comprises an industrial rotary kiln with a cylindrical inner lining of the type explained above.

FIG. 5 displays, in a highly schematic manner, a vertical cut through a cement rotary kiln with an outer kiln envelope 20 and a cylindrical refractory lining 30, arranged radially to the inside between a kiln entrance OE and a kiln exit OA. In an axial direction (arrow A) several rings 30a . . . 30z made of conventional arch bricks are arranged one behind the other, as know per se. About 1 m ahead of kiln exit OA ring 30w is shown, made of arch bricks according to the invention, namely of arch bricks according to FIG. 2.

According to the invention the separation planes/slope surface TF between brick parts 10,12 takes over the task of a counter bearing to compensate at least partially the axial pressure forces (P_{A}) deriving from the arch bricks arranged ahead (towards the kiln entrance) and to deflect these forces into the kiln wall 20 and adjacent ach bricks.

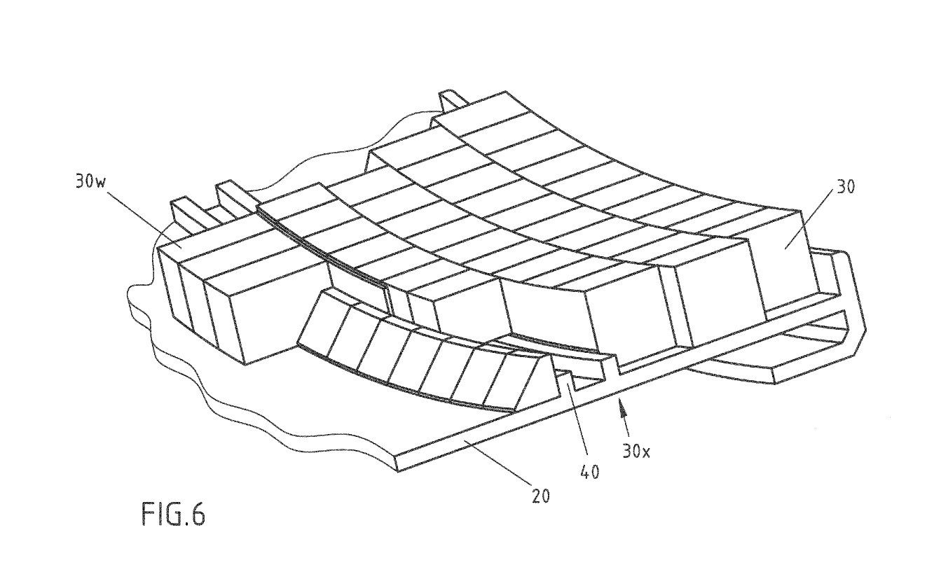

FIG. 6 displays a perspective, partly cut-away inner view onto a part of the refractory lining 30 of a rotary kiln along a brick layer 30w made of multi-part arch bricks according to invention and according to FIG. 3.

A conventional steel ring 40 according to prior art is mounted in the following brick layer (row) and serves as an additional retaining means against axial pressure P_{A.} But this is optional.

1. An arch brick in accordance with DIN 1082-4, edition January 2007, which is separated into two discrete brick parts (10, 12) along at least one separation plane (TF), which extends from base (AG) to a front face (TS2) or a further base (IG).

2. The arch brick according to claim 1, the separation plane (TF) of which extends by an angle ≧20 degrees to said base (AG).

3. The arch brick according to claim 1, the separation plane (TF) of which extends by an angle ≦75 degrees to said base (AG).

4. The arch brick according to claim 1, the separation plane (TF) of which extends by an angle ≦60 degrees to said base (AG).

5. The arch brick according to claim 1, with at least one brick part (10, 12) having two opposed surfaces (RS1*, RS2*), each of trapezoidal shape.

6. The arch brick according to claim 1, with at least one brick part (10, 12) having two opposed surfaces (RS1*, RS2*), each of triangular shape.

7. The arch brick according to claim 1, with at least one brick part (10, 12) having two opposed surfaces (RS1*, RS2*), each of pentagonal shape.

8. The arch brick according to claim 5 wherein the opposed surfaces (RS1*, RS2*) are identical.

9. The arch brick according to claim 1, which separation plane (TF) being planar.

10. Cylindrical inner lining (30) of an industrial rotary kiln with the following features:
a) the lining (30) extends between a kiln entrance (OE) at a first end of the rotary kiln and a kiln exit (OA) at a second end of the rotary kiln,
b) the lining (30) is substantially made of ring-like segments (30a . . . 30z) arranged one behind the other, wherein
c) at least one ring-like segment (30w) is made at least predominantly of arch bricks according to claim 1, which abut each other in a peripheral direction with their side faces (RS1, RS2) and which large bases AG are arranged to the outside, wherein
d) said separation planes (TF) of said arch bricks extend from the large base (AG) towards the kiln exit (OA).

11. Lining according to claim 10 with arch bricks wherein the separation plane (TF) of which extends by an angle to said base that is at least one of ≧20 degrees, ≦75 degrees or ≦60 degrees.

12. Industrial rotary kiln with a cylindrical inner lining according to claim 10.

13. The arch brick according to claim 6 wherein the opposed surfaces are identical.

14. The arch brick according to claim 7 wherein the opposed surfaces are identical.

15. Lining according to claim 10 with arch bricks with at least one brick part having two opposed surfaces, each of the two opposed surfaces being trapezoidal, triangular, pentagonal or planar shape.

16. Lining according to claim 15 with arch bricks with at least one brick part having two opposed surfaces, wherein if the opposed surfaces are trapezoidal, triangular, or pentagonal, the opposed surfaces (RS1*, RS2*) are identical.

17. Lining according to claim 15 with arch bricks wherein the separation plane (TF) of which extends by an angle to said base that is at least one of ≧20 degrees, ≦75 degrees or ≦60 degrees.

18. Lining according to claim 16 with arch bricks wherein the separation plane (TF) of which extends by an angle to said base that is at least one of ≧20 degrees, ≦75 degrees or ≦60 degrees.
